(19) United States
(12) Patent Application Publication
(10) Pub. No.: US 2026/0246188 A1
(43) Pub. Date: Aug. 20, 2026

(54) SOCKET HOUSING AND ELECTRICAL CONNECTOR

(71) Applicants: Fuyu Electronic Technology (Huai'an) Co., Ltd., Huai'an (CN); FOXCONN INTERCONNECT TECHNOLOGY LIMITED, Grand Cayman (KY)

(72) Inventors: CHUN-LEI ZHOU, Huaian (CN); XUN WU, Huaian (CN); XIAO-HU YIN, Huaian (CN); XUE-WU BU, Kunshan (CN)

(21) Appl. No.: 19/535,265

(22) Filed: Feb. 10, 2026

(30) Foreign Application Priority Data
Feb. 19, 2025 (CN) 202520272322.5

(51) Int. Cl. H01R 13/502; H01R 12/71

(52) U.S. Cl. CPC H01R 13/502; H01R 12/716

(57) ABSTRACT

An electrical connector includes a socket body, and a socket housing sleeving the socket body. The socket housing includes a top housing plate, two side housing plates, and two first end housing plates. The top housing plate has fingers at two sides of the slot, and the fingers are bent perpendicularly and are inserted into restricting holes at a top portion of the socket body. The two side housing plates are respectively perpendicularly connected to opposite sides of the top housing plate, and each side housing plate has a plurality of recessed portions. Each of the recessed portions is bent toward the socket body and inserted into restricting slots of the socket body. The two first end housing plates are respectively perpendicularly connected to corresponding sides of the two side housing plates, and a connection between the two first end housing plates has interlocking first tooth portions.

### BACKGROUND OF THE INVENTION

### Field of the Invention

The present invention relates to an electrical connector and a socket housing thereof.

### Description of Related Arts

Currently, in server-related technologies, motherboards are typically equipped with socket connectors for high-speed busbars. These sockets are used connecting to external devices and hardware, and usually have a housing for protection. However, the housing is often not strong enough and is prone to cracking after repeated plugging and unplugging operations, especially cracks caused by the housing bulging outwards on both sides of the socket.

### SUMMARY OF THE INVENTION

An electrical connector includes a socket body, and a socket housing sleeving the socket body. The socket housing includes a top housing plate arranged over a top portion of the socket body and having a slot aligned to a socket of the socket body, two side housing plates, and two first end housing plates. The top housing plate has fingers at two sides of the slot, and the fingers are bent perpendicularly and are inserted into restricting holes at the top portion of the socket body for restricting a movement of the top housing plate relative to the socket body in a length-wise direction and a width-wise direction. The two side housing plates are respectively perpendicularly connected to opposite sides of the top housing plate, and each side housing plate has a plurality of recessed portions. Each of the recessed portions is bent toward the socket body and inserted into restricting slots of the socket body for restricting a movement of the socket housing relative to the socket body in a height-wise direction. The two first end housing plates are respectively perpendicularly connected to corresponding sides of the two side housing plates, and a connection between the two first end housing plates has interlocking first tooth portions for restricting a movement of the two side housing plates relative to the socket body in the width-wise direction.

### BRIEF DESCRIPTION OF DRAWINGS

FIG. 1 shows an exploded view of a socket housing and a socket body according to an embodiment of the present disclosure;

FIG. 2 shows a perspective view of the socket housing and the socket body of FIG. 1 after assembly;

FIG. 3 shows a perspective view of the socket housing and the socket body of FIG. 2 after assembly from another perspective;

FIG. 4 shows a perspective view of a first end housing plate of the socket housing of FIG. 3;

FIG. 5 shows a perspective view of a second end housing plate of the socket housing of FIG. 1;

FIG. 6 shows a cutaway view of the socket housing of FIG. 1; and

FIG. 7 shows a cutaway view of the socket body of FIG. 1.

### DETAILED DESCRIPTION OF THE DRAWINGS

The technical solutions of the present disclosure is described with reference to the accompanying drawings of the embodiments. Obviously, the described embodiments are only a part of the embodiments of the present disclosure, and not all of the embodiments.

It should be noted that when an element is considered to be “connected to” or “arranged on” another element, it can be directly connected to the other element or may be an element arranged within at the same time. In the present disclosure, unless otherwise explicitly specified and restricted, terms such as “installation,” “connection,” and “fixture” should be interpreted broadly. For example, it can refer to a fixed connection, a detachable connection, or an integral connection; it can be a mechanical connection or an electrical connection; it can be a direct connection or an indirect connection through an intermediate medium; it can be an internal connection between two elements. Those skilled in the art can understand the specific meaning of the above terms in the present disclosure according to the specific situations.

Terms such as “first,” “second,” etc., are only used to distinguish different objects and should not be construed as indicating or implying relative importance or implicitly specifying the number, specific order, or primary or secondary relationship of the indicated technical features. In the description of the embodiments of the present disclosure, “plurality” means two or more, unless otherwise explicitly specified. The descriptions of length, thickness, width, and other shapes in the embodiments of the present disclosure are merely illustrative and should not constitute any absolute limitation on the present disclosure. The terms “perpendicular” and “parallel” are used to describe the ideal state between two components; in actual production or use, a state approximately perpendicular or parallel may exist.

Unless otherwise defined, all technical and scientific terms used herein have the same meaning as commonly understood by one of ordinary skill in the art to which the present disclosure pertains. The terminology used herein is for the purpose of describing particular embodiments only and is not intended to limit the present disclosure. The terms “comprising,” “having,” and “equipped with,” and any variations thereof, in the specification, claims, and foregoing drawings of the present disclosure, are intended to cover non-exclusive inclusion. The reference to “embodiment” herein means that a particular feature, structure, or characteristic described in connection with an embodiment may be included in at least one embodiment of the present disclosure. The appearance of this phrase in various places in the specification does not necessarily refer to the same embodiment, nor is it a mutually exclusive, independent, or alternative embodiment. Unless conflict exists, the various embodiments in the present disclosure can be combined with each other.

Unless otherwise defined, all technical and scientific terms used herein have the same meaning as commonly understood by one of ordinary skill in the art to which this application belongs. The terminology used herein is for the purpose of describing particular embodiments only and is not intended to limit the scope of the application. The term “or/and” as used herein includes any and all combinations of one or more of the associated listed items.

Currently, in server-related technologies, motherboards typically have socket connectors for high-speed busbars. The sockets are used to connect external devices and hardware, and typically have housings for protection. However, the strength of these housings is often insufficient, and the housings are prone to cracking under repeated insertion and removal, especially cracking caused by the outward expansion of the housing on two sides of the socket.

Therefore, it is necessary to provide a socket housing with higher strength and an electrical connector having the socket housing. The socket housing sleeves the socket body and is formed by bending a plate. The plate includes a top housing plate, two side housing plates, and two first end housing plates. The top housing plate is positioned at the top of the socket body and has a slot. The slot aligns to the socket of the socket body. The top housing plate has fingers arranged at two sides of the slot. The fingers are bent perpendicularly relative to the top housing plate and are inserted into restricting holes at the top of the socket body to restrict the movement of the top housing plate relative to the socket body in the length-wise and width-wise directions. The two side housing plates are perpendicularly connected to opposite ends of the top housing plate. Each of the side housing plates has a plurality of recessed portions that are bent at an angle relative to the side housing plate towards the socket body and are inserted into restricting slots of the socket body to restrict the movement of the socket housing relative to the socket body in the height-wise direction. Two first end housing plates are respectively perpendicularly connected to corresponding sides of the two side housing plates. The connection between the two first end housing plates has an interlocking first tooth portion to restrict the movement of the two side housing plates relative to the socket body in the width-wise direction.

When using the socket housing, by inserting the fingers on two sides of the socket into the restricting holes at the top of the socket body, the movement of the top housing plate relative to the socket body in the length-wise and width-wise directions is restricted, thereby preventing cracking caused by the outward expansion of the top housing plate on two sides of the socket. Furthermore, by inserting the recessed portion into the restricting groove of the socket body, the movement of the socket housing relative to the socket body in the height-wise direction is restricted, thereby preventing the socket housing from detaching from the socket body, thus preventing cracking caused by the outward expansion of the two side housing plates. Additionally, the first tooth portion restricts the movement of the two side housing plates relative to the socket body in the width-wise direction, thereby preventing the two side housing plates from moving away from each other, thus preventing cracking caused by the outward expansion of the two side housing plates.

The following describes some embodiments of the present disclosure in detail with reference to the accompanying drawings. Unless otherwise specified, the following embodiments and features can be combined with each other.

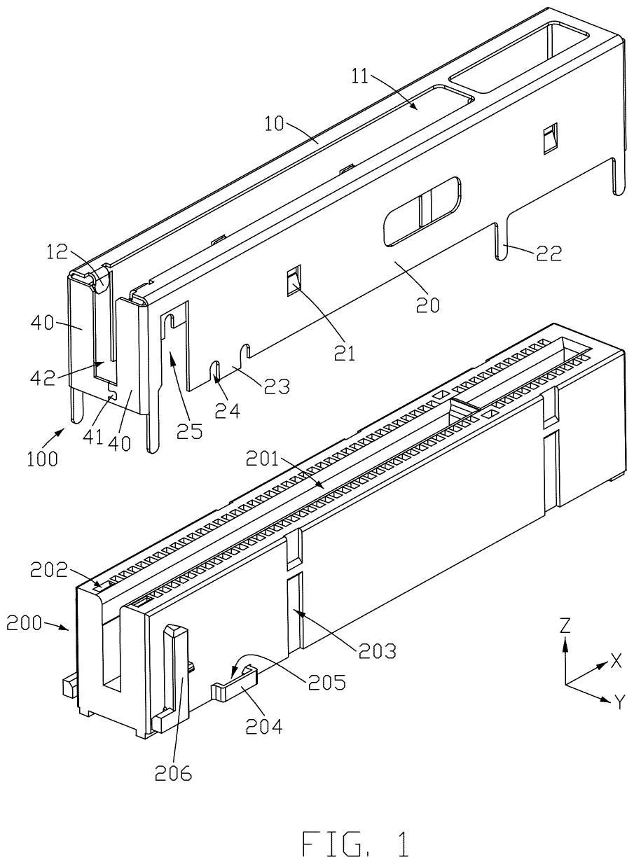

As shown in FIGS. 1 to 3, an embodiment of the present disclosure application provides an electrical connector. The electrical connector can be mounted on a motherboard. The electrical connector includes a socket body 200 and a socket housing 100. The socket body 200 can be a PCIe (Peripheral Component Interconnect Express) socket, which is a high-speed, high-bandwidth serial interconnect technology specifically designed to connect peripherals on the computer motherboard. The socket body 200 is used to connect to external devices, such as graphic cards, audio cards, network cards, or hard drives. The socket housing 100 sleeves the socket body 200 to provide protection. The electrical connector further includes terminals mounted to the socket body 200.

The socket housing 100 is formed by bending, stamping and puncturing a plate. As shown in FIGS. 1 to 3, the plate includes a top housing plate 10 arranged at a top portion of the socket body 200 and has a slot 11. The slot 11 is aligned to a socket 201 of the socket body 200. The top housing plate 10 has fingers 12 arranged respectively at opposite sides of the slot 11. The fingers 12 are bent perpendicularly relative to the top housing plate 10 and inserted into restricting holes 202 at the top portion of the socket body 200. The fingers 12 restrict the movement of the top housing plate 10 relative to the socket body 200 along the length-wise direction X and the width-wise direction Y, particularly in the width-wise direction Y. Given that the top housing plate 10 has a hollow central area, i.e. the slot 11, after repeated insertion and removal operations, the top housing plate 10 is prone to cracking due to outward expansion in the width-wise direction Y. Therefore, the fingers 12 prevent the portions of the top shell housing 10 on both sides of the slot 11 from cracking along the width-wise direction Y, thus improving the reliability of the socket housing 100.

The socket housing 100 also includes two side housing plates 20. The two side housing plates 20 are perpendicularly connected to opposite sides of the top housing plate 10 and arranged on opposite sides of the socket body 200. Each side housing plate 20 has a plurality of recessed portions 21. The recessed portions 21 are bent at an angle relative to the side housing plate 20 towards the socket body 200. The recessed portions 21 are inserted into restricting grooves 203 of the socket body 200. By abutting against the wall of the restricting grooves 203, the recessed portions 21 restrict the movement of the socket housing 100 relative to the socket body 200 in the height-wise direction Z. This prevents the socket housing 100 from detaching from the socket body 200 during insertion and removal operations, thus preventing the socket housing 100 from being raised. When the socket housing 100 is raised, the interior thereof is not filled and supported by the socket body 200, leading to reduced structural strength and increased susceptibility to deformation and cracking. Therefore, the cooperation between the recessed portions 21 and the restricting grooves 203 prevents the socket housing 100 from detaching from the socket body 200, improving the reliability of the socket housing 100.

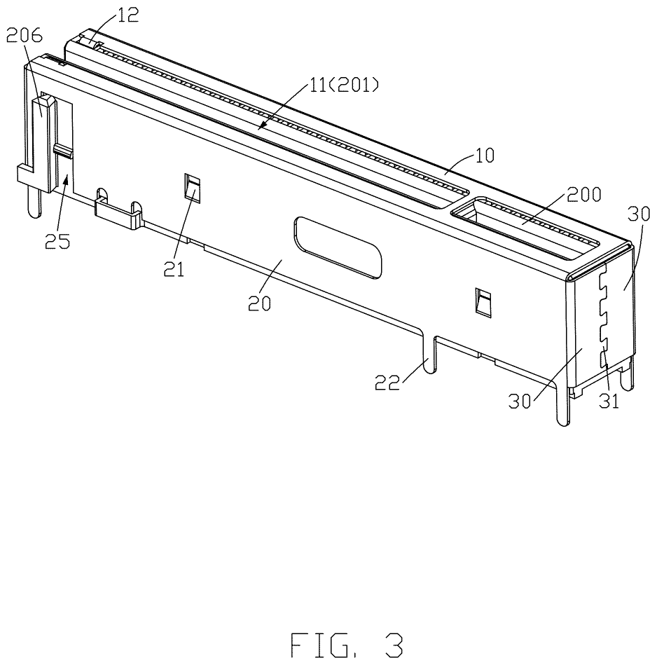

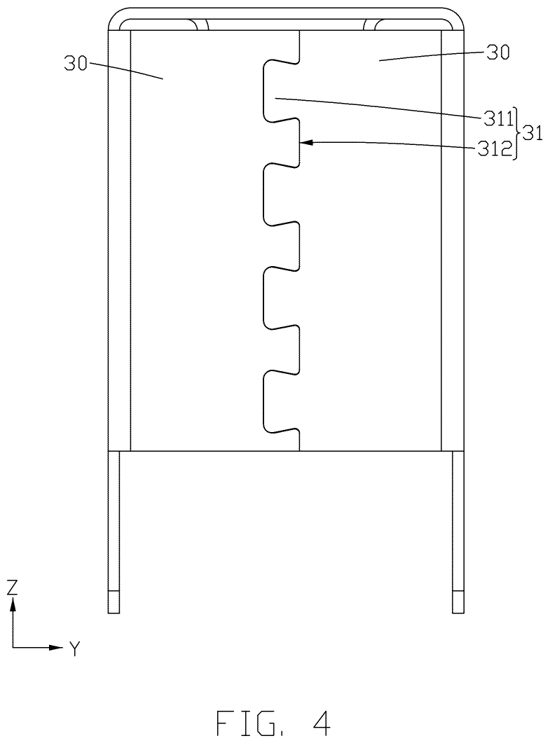

As shown in FIGS. 3 and 4, the plate of the socket housing 100 further includes two first end housing plates 30. The two first end housing plates 30 are respectively perpendicularly connected to corresponding sides of the two side housing plates 20, and are arranged at the same end of the socket body 200. The connection between the two first end housing plates 30 has an interlocking first tooth portion 31 to restrict the movement of the two side housing plates 30 relative to the socket body 200 in the width-wise direction Y, for restricting the two side housing plates 20 from moving away from each other and spreading outwards, thus preventing the socket housing 100 from cracking and improving the reliability of the socket housing 100.

In some embodiments, as shown in FIGS. 1, 2, and 5, the plate of the socket housing 100 further includes two second end housing plates 40. The two second end housing plates 40 are respectively perpendicularly connected to corresponding sides of the two side housing plates 20 away from the two first end housing plates 30. The connection between the two second end housing plates 40 has an interlocking second tooth portion 41 to restrict the movement of the two side shell plates 30 relative to the socket body 200 in the width-wise direction Y, for restricting preventing the two side housing plates 20 from moving away from each other and outwards, thus preventing the socket housing 100 from cracking and improving the reliability of the socket housing 100. Preferably, the first tooth portion 31 and the second tooth portion 41 both exist. Given that the socket body 200 is a long rectangular strip and the socket housing has two ends in the length-wise direction X, the first tooth portion 31 and the second tooth portion 41 can together enhance the structural strength of the socket housing 100 at said ends, restricting the two side housing plates 20 from moving away from each other and outwards at said ends, thus preventing the socket housing 100 from cracking and improving the reliability of the socket housing 100.

In some embodiments, as shown in FIGS. 3 and 4, the first tooth portion 31 includes a plurality of first teeth 311, and a first tooth groove 312 is formed between every two neighboring first teeth 311. The first teeth 311 of each first end housing plate 30 are inserted into the first tooth grooves 312 of the other first end housing plate 30. A width of each first tooth 311 gradually increases toward the free end thereof. Namely. a dimension of each first tooth 311 in the height-wise direction Z gradually increases in the direction from the first end housing plate 30 on which it is disposed to the other first end housing plate 30. A width of each first tooth groove 312 gradually increases from the opening thereof. Namely, a dimension of each first tooth groove 312 in the height-wise direction Z gradually increases along the direction from the other first end housing plate 30 to the first end housing plate 30 on which it is disposed. In this way, each first tooth 311 can be confined in the corresponding first tooth groove 312 along the width-wise direction Y, thereby restricting the two first end housing plates 30 from moving away from each other along the width-wise direction Y, thus restricting the movement of the two side housing plates 20 relative to the socket body 200 in the width-wise direction Y, thereby preventing the socket housing 100 from cracking and improving the reliability of the socket housing 100.

In some embodiments, as shown in FIGS. 1, 2, and 5, each of the two second end housing plates 40 has a notch 42. The notches 42 are in fluid communication with each other, and respectively extend through the top of the two second end housing plates 40. The socket 201 of the socket body 200 extends through the socket body 200 along the length-wise direction X and aligns to the notches 42 to allow for the insertion of an external device. The second tooth portion 41 is arranged below the notches 42. The second tooth portion 41 includes a second tooth 411 and a second tooth groove 412. The second tooth 411 is disposed on one second end housing plate 40, and the second tooth groove 412 is disposed on the other second end housing plate 40. The second tooth 411 is inserted into the second tooth groove 412. Similar to the first tooth 311 and the first tooth groove 312, a width of the second tooth 411 gradually increases toward the free end thereof, and the width of the second tooth groove 412 gradually increases from the opening thereof. This confines the second tooth 411 in the second tooth groove 412 along the width-wise direction Y, thereby restricting the two second end housing plates 40 from moving away from each other, in turn restricting the movement of the two side housing plates 20 relative to the socket body 200 in the width-wise direction Y, thus preventing cracking of the socket housing 100 and improving the reliability of the socket housing..

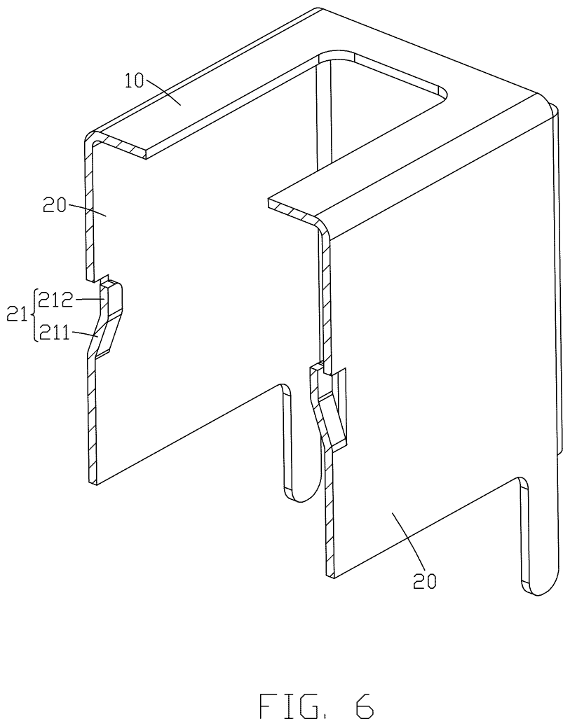

In some embodiments, as shown in FIGS. 1 and 6, each recessed portion 21 includes an inclined portion 211 and a vertical portion 212. One end of the inclined portion 211 is connected to the side housing plate 20 and the inclined portion 211 bends at an angle relative to the side housing plate 20 toward the socket body 200. The vertical portion 212 is connected to the end of the inclined portion 211 distal from the side housing plate 20 and is substantially parallel to the side housing plate 20. The inclined portion 212 deforms when the socket housing 100 is installed onto the socket body 200 in a top to bottom direction, and returns to its original shape when the vertical portion 212 aligns to the restricting groove 203, such that the vertical portion 212 automatically inserts into the restricting groove 203. The top end of the vertical portion 212 abuts the groove wall of the restricting groove 203 to restrict the movement of the socket housing 100 relative to the socket body 200 in the height-wise direction Z, thereby preventing the socket housing 100 from detaching from the socket body 200.

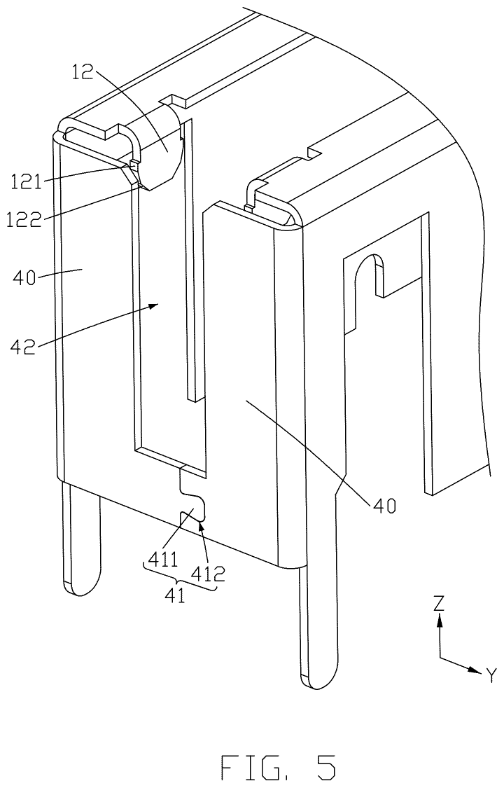

In some embodiments, as shown in FIGS. 1 and 5, the finger 12 has protrusions 121 on opposite sides thereof. The bottom portion of each protrusion 121 has a guide face 122 which is chamfered or rounded. The guide face 122 guides the finger 12 into the restricting hole 202. The protrusions 121 press against the wall of the restricting hole 202, so as to engage the restricting hole and increase friction between the finger 12 and the socket body 200, improving the stability of the finger 12 in the restricting hole 202.

In some embodiments, as shown in FIGS. 1 to 3, each of the side housing plates 20 has a plurality of legs 22 at a bottom portion thereof. The legs 22 pass through the motherboard supporting the socket body 200 and are soldered to the motherboard to fix the socket housing 100 to the motherboard, improving the stability of the socket housing 100. Exemplarily, each of the side housing plates 20 has three legs 22 at the bottom portion thereof, arranged at both ends and between the two ends along the length-wise direction X of the side housing plate 20, respectively, to ensure the stability of the socket housing 100 on the motherboard.

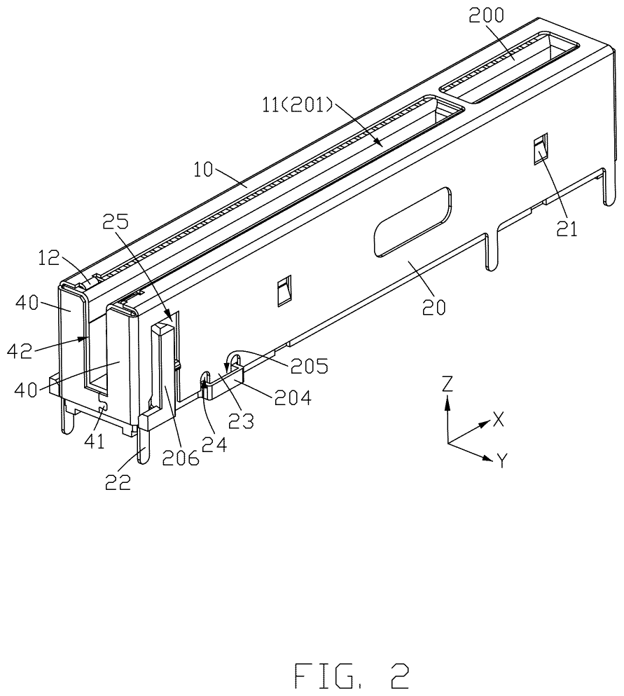

In some embodiments, as shown in FIGS. 1 and 2, each of the side housing plates 20 has a positioning plate 23 at the bottom portion thereof and clearance notches 24 on two sides of the positioning plate 23. The socket body 200 has protruding portions 204 on two sides thereof, and each of the protruding portions 204 has a positioning hole 205. The positioning hole 205 extends through the protruding portion 204 along the height-wise direction Z of the socket body 200. When the socket housing 100 is installed onto the socket body 200 from top to bottom, the positioning plate 23 is inserted into the positioning hole 205, and the protruding portion 204 is partially accommodated into the clearance notches 24, thus restricting the movement of the socket housing 100 relative to the socket body 200 in the length-wise direction X and the width-wise direction Y, improving the stability of the socket housing 100 relative to the socket body 200.

In some embodiments, as shown in FIGS. 1 to 3, each side housing plate 20 has a clearance hole 25. The clearance hole 25 extends through the bottom portion of the side housing plate 20. The socket body 200 has protruding bars 206 on two sides. The protruding bars 206 are used to engage other components in the server. When the socket housing 100 is installed onto the socket body 200 from top to bottom, the clearance hole 25 is aligned to the protruding bar 206, allowing the side housing plate 200 to avoid the protruding bar 206 and thus prevent interference.

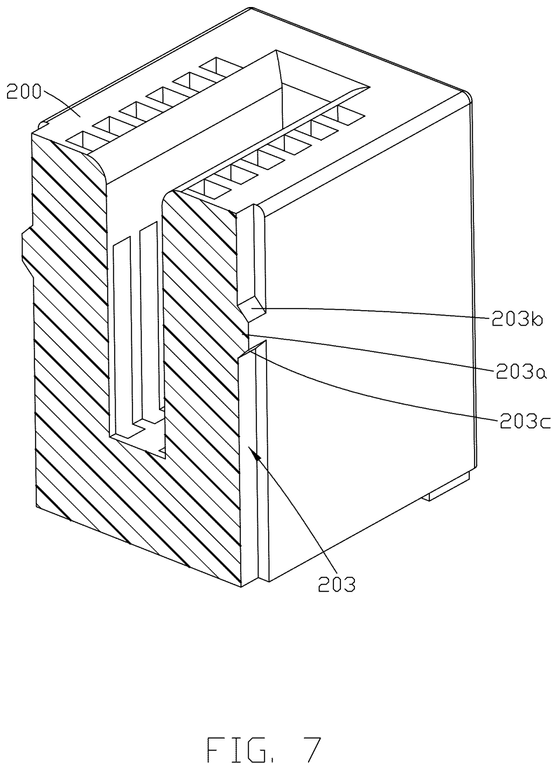

In some embodiments, as shown in FIGS. 1, 6, and 7, the restricting groove 203 of the socket body 200 has a protruding block 203a. The protruding block 203a has a first inclined face 203b facing upwards and a second inclined face 203c facing downwards. When the socket housing 100 is installed onto the socket body 200 from top to bottom, the first inclined face 203b contacts the inclined portion 211. The inclined portion 211 slides and deforms along the first inclined face 203b until passing over the protruding block 203a and the vertical portion 212 is located below the second inclined face 203c. The top of the vertical portion 212 abuts the second inclined face 203c to prevent the socket housing 100 from detaching from the socket body 200. The second inclined face 203c can guide the vertical portion 212 to slide along thereon when the user disassembles the socket housing 100, allowing the vertical portion 212 to pass over the protruding block 203a for easy disassembly.

Furthermore, those skilled in the art should recognize that the above embodiments are merely illustrative of the present disclosure and not intended to limit the same. Any reasonable changes and variations made to the above embodiments in the spirit and scope of the present disclosure fall within the scope of the present disclosure.

1. An electrical connector comprising:
a socket body; and
a socket housing sleeving the socket body and including a top housing plate arranged over a top portion of the socket body and having a slot aligned to a socket of the socket body, two side housing plates, and two first end housing plates; wherein
the top housing plate has fingers at two sides of the slot, and the fingers are bent perpendicularly and are inserted into restricting holes at the top portion of the socket body for restricting a movement of the top housing plate relative to the socket body in a length-wise direction and a width-wise direction;
the two side housing plates are respectively perpendicularly connected to opposite sides of the top housing plate, and each side housing plate has a plurality of recessed portions, each of the recessed portions is bent toward the socket body and inserted into restricting slots of the socket body for restricting a movement of the socket housing relative to the socket body in a height-wise direction; and
the two first end housing plates are respectively perpendicularly connected to corresponding sides of the two side housing plates, and a connection between the two first end housing plates has interlocking first tooth portions for restricting a movement of the two side housing plates relative to the socket body in the width-wise direction.

2. The electrical connector according to claim 1, further comprising two second end housing plates, wherein the two second end housing plates are respectively perpendicularly connected to the sides of the two side housing plates distal from the two first end housing plates, and a connection between the two second end housing plates has an interlocking second tooth portion to restrict the movement of the two side housing plates relative to the socket body in the width-wise direction.

3. The electrical connector according to claim 1, wherein the first tooth portion comprises a plurality of first teeth, a first tooth groove is formed between every two neighboring first teeth, the first teeth of each of the first end housing plates are inserted into the first tooth groove of the other first end housing plate, a width of each of the first teeth gradually increases the free end thereof, and a width of each of the first tooth grooves gradually increases from the opening thereof, such that each of the first teeth is confined in the corresponding first tooth groove to restrict the two first end housing plates from moving away from each other, thereby restricting the movement of the two side housing plates relative to the socket body in the width-wise direction.

4. The electrical connector according to claim 2, wherein each of the two second end housing plates has a notch, the notches are in fluid communication with each other and passes through a top portion of each of the two second end housing plates, the socket of the socket body pass through the socket body in the length-wise direction and aligns to the notches, the second tooth portion is arranged below the notches; the second tooth portion has a second tooth and a second tooth groove, the second tooth is disposed on one of the second end housing plates, the second tooth groove is disposed on the other second end housing plate, the second tooth is inserted into the second tooth groove, a width of the second tooth gradually increases toward the free end thereof, and a width of the second tooth groove gradually increases from the opening thereof, such that the second tooth is restricted in the second tooth groove, thereby restricting the two second end housing plates from moving away from each other, thus restricting the movement of the two side housing plates relative to the socket body in the width-wise direction.

5. The electrical connector according to claim 1, wherein each recessed portion comprises an inclined portion and a vertical portion, one end of the inclined portion is connected to the side housing plate, the inclined portion bends at an angle relative to the side housing plate toward the socket body, the vertical portion is connected to the end of the inclined portion distal from the side housing plate and is parallel to the side housing plate, the inclined portion deforms when the socket housing is installed onto the socket body from top to bottom and returns to an original shape when the vertical portion aligns to the restricting groove such that the vertical portion is inserted into the restricting groove, and the top end of the vertical portion abuts a wall of the restricting groove to restrict the movement of the socket housing relative to the socket body in the height-wise direction.

6. The electrical connector according to claim 1, wherein the finger has protrusions on opposite sides thereof, a bottom portion of each of the protrusions has a guide face for guiding the finger into the restricting hole, and the protrusion and the restricting hole are engageable to each other.

7. The electrical connector according to claim 1, wherein each of the side shell plates has a plurality of legs at a bottom portion thereof, and the legs are for passing through and being fixed to a motherboard supporting the socket body, thereby fixing the socket housing to the motherboard.

8. The electrical connector according to claim 1, wherein each of the side housing plates has a positioning plate at a bottom portion thereof, and clearance notches on two sides of the positioning plate, the socket body has protruding portions on two sides thereof, each of the protruding portion has a positioning hole extending through the protruding hole along the height-wise direction of the socket body, when the socket housing is installed onto the socket body from top to bottom, the positioning plates are respectively inserted into the positioning holes, and the protruding portions are inserted into the clearance notches, thereby restricting the movement of the socket housing relative to the socket body in the length-wise direction and the width-wise direction.

9. The electrical connector according to claim 1, wherein each of the side housing plates has clearance holes extending through a bottom portion of the side housing plate, the socket body has protruding bars on two sides thereof, and when the socket housing is installed onto the socket body from top to bottom, the clearance holes are aligned to the protruding bars, allowing the side housing plates to avoid the protruding bars.

10. A socket housing comprising:
a top housing plate having a slot, and two fingers arranged at two sides of the slot;
two side housing plates respectively perpendicularly connected to opposite sides of the top housing plate, and each having a plurality of recessed portions; and
two first end housing plates respectively perpendicularly connected to corresponding sides of the two side housing plates, wherein a connection between the two first end housing plates has interlocking first tooth portions.
